(19) United States
(12) Patent Application Publication
(10) Pub. No.: US 2022/0330020 A1
(43) Pub. Date: Oct. 13, 2022

(54) METHODS AND APPARATUS FOR AUTOMATED MULTI-FACTOR AUTHENTICATION

(71) Applicant: Amir Keyvan Khandani, Kitchener (CA)

(72) Inventor: Amir Keyvan Khandani, Kitchener (CA)

(21) Appl. No.: 17/707,519

(22) Filed: Mar. 29, 2022

Related U.S. Application Data
(60) Provisional application No. 63/172,563, filed on Apr. 8, 2021.

(51) Int. Cl. H04W 12/06; H04L 67/55; H04W 12/71

(52) U.S. Cl. CPC H04W 12/06; H04L 67/26; H04W 12/71; H04W 4/80

(57) ABSTRACT

A server performed method includes receiving, from a first device, a request for authentication by the server, wherein the request includes a unique identifier of the first device, and upon verifying that the unique identifier is registered at the server, sending a push notification to the first device and to a second device registered as associated with the first device. A first list of IDs of at least one wireless device within wireless communication range of the first device is received from the first device, and a second list of IDs of at least one wireless device within wireless communication range of the second device is received from the second device. The first and second list of IDs are compared to identify common IDs between the first list and the second list. Successful authentication of the first device is confirmed when at least one common ID is identified.

### CROSS-REFERENCE TO RELATED APPLICATIONS

The present application is a non-provisional filing of, and claims benefit under 35 U.S.C. § 119(e) from, pending U.S. Provisional Patent Application Ser. No. 63/172,563, titled “METHODS AND APPARATUS FOR AUTOMATED MULTI-FACTOR AUTHENTICATION” and filed Apr. 8, 2021, which is incorporated herein by reference in its entirety.

### FIELD

The present disclosure relates to secure communications. In particular, the present disclosure relates to systems and methods for user authentication.

### BACKGROUND

Embodiments herein relate to methods to establish and/or enhance the security of data exchange between two legitimate nodes in the presence of an eavesdropper.

Embodiments further relate to the general area of data security, methods for authentication, secure data exchange, and secure storage.

### SUMMARY

One or more embodiments include a method performed by a server, a first device and a second device, associated apparatus and a non-transitory computer-readable storage medium. A method performed by a server includes receiving, from a first device, a request for authentication by the server, wherein the request includes a unique identifier of the first device, and upon verifying that the unique identifier is registered at the server, sending a push notification to the first device and to a second device registered as associated with the first device. A first list of identifiers (IDs) of at least one wireless device within wireless communication range of the first device is received from the first device, and a second list of IDs of at least one wireless device within wireless communication range of the second device is received from the second device. The first list of IDs and the second list of IDs are compared to identify common IDs between the first list and the second list. Successful authentication of the first device is confirmed when at least one common ID is identified. A method performed by a first device includes sending, by the first device, a request for authentication to a server, wherein the request includes a unique identifier of the first device, wherein the unique identifier is registered at the server and receiving, by the first device, a push notification from the server upon verifying the unique identifier of the first device. In response to receiving the push notification, a list of IDs of at least one wireless device within wireless communication range of the first device is sent to the server and confirmation of authentication is received from the server. A method performed by a second device includes receiving, by the second device associated with a first device, a push notification from a server, wherein the first device and the second device are registered with the server and identifying at least one wireless device within wireless communication range of the second device. In response to receiving the push notification, a list of IDs of the at least one wireless device within wireless communication range of the second device is sent to the server. A method performed by a system includes sending, by a first device, a request for authentication to a server, wherein the request includes a unique identifier of the first device, wherein the unique identifier is registered at the server, and receiving, from the first device, the request for authentication by the server. Upon verifying that the unique identifier is registered at the server, a push notification is sent to the first device and to a second device registered at the server as associated with the first device. In response to receiving the push notification, a first list of IDs of at least one wireless device within wireless communication range of the first device is sent from the first device to the server. In response to receiving the push notification, a second list of IDs of at least one wireless device within wireless communication range of the second device is sent from the second device to the server. The first list of IDs is received from the first device, and the second list of IDs is received from the second device. The first list of IDs and the second list of IDs are compared to identify common IDs between the first list and the second list. Successful authentication of the first device is confirmed when at least one common ID is identified.

### BRIEF DESCRIPTION OF THE DRAWINGS

FIG. 1 illustrates a computer and a cell phone as connected to an authentication server in accordance with at least one embodiment.

FIG. 2 illustrates environmental signatures for neighboring routers in accordance with at least one embodiment.

FIG. 3 illustrates environmental signatures for Bluetooth devices in accordance with at least one embodiment.

FIG. 4 illustrates a computer and a cell phone in an authentication process that may include user interaction in accordance with at least one embodiment.

FIG. 5 illustrates use of a STUN server to provide a direct link through the cloud between two devices in accordance with at least one embodiment.

FIG. 6 illustrates a method of transparent encryption in accordance with at least one embodiment.

FIG. 7 illustrates use of a second server to store part of a private encryption keys in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments herein.

The apparatus and method components have been represented where appropriate by conventional symbols in the drawings, showing only those specific details that are pertinent to understanding the embodiments of the present embodiments so as not to obscure the disclosure with details that will be readily apparent to those of ordinary skill in the art having the benefit of the description herein.

### DETAILED DESCRIPTION

The present description discloses techniques for multi-factor authentication to verify a user and/or user devices.

Multi-factor authentication is the process of using several independent mechanisms to verify the identity of a claimant. A vast majority of multi-factor authentication techniques involve using several devices belonging to the same user, where each device has a separate communications link to a server such as the cloud. This process includes verifying that at least two such devices are used in the authentication procedure. For example, a person trying to access an on-line service receives a short messaging system (SMS) on their phone with a one-time password that the user needs to enter into an interface in addition to their regular password. As another example, a yes/no question is sent to the user's cell phone asking if an access request is legitimate or not. For example, a person aiming to login from home to the person's computer system at work, upon entering the person's password on the login interface, receives a message on the person's phone asking the person to select (activate) the “YES” option if the request is truly from the person, or select (activate) the “NO” option, if the request is not.

A shortcoming of the above multi-factor authentication procedures is lack of convenience because the user needs to actively participate in the process, for example, a user may enter a one-time password or activate a “YES/NO” input. A first problem is that the user needs to have his/her cell phone handy, and a second problem is that such procedures are required to have a long life (wait) time because the interaction from the user may take several seconds or even minutes to conclude. The long wait time opens the door for hackers to interfere with, or even highjack, the authentication process.

On the other hand, a typical cell phone has, in addition to cellular connection, Wi-Fi as well as Bluetooth and possibly Near Field (NF) communications capabilities. Typically, the cell phone and the computer used for access are both connected to the same Wi-Fi network, and also see similar items in the list of neighboring or nearby Wi-Fi access points.

To overcome shortcomings with existing authentication techniques, in an embodiment, a method verifies whether the cell phone and the computer used by the person are connected to or within range of the same Wi-Fi network. An authentication server sends a request to the computer as well as to the cell phone, asking these two devices to send over the MAC address or other identification of the Wi-Fi network to which the devices are connected. Other identifiers such as the Service Set Identifier (SSID) of the Wi-Fi network may be used instead or in combination with the MAC address and may, for example, be hashed. This information is known as a signature associated with a device's environment, also referred to as an environmental signature. If the two signatures match, the condition for access is recorded or identified as affirmative, and a token is sent to a provider of the requested service indicating that the user should be granted access. In this embodiment, the authentication server has stored records of users' cell phone numbers, or tokens, that enable the authentication server to send push notifications to cell phones registered to users of the authentication service. To enhance the authentication procedure, in another embodiment, the server also records a unique identifier for a cell phone and/or a unique identifier for a computer. The cell phone and the computer each, in addition to the signature extracted from their environment based on their Wi-Fi connections, send their respective unique identifier to the server, enabling the server to verify that the devices belong to the user as claimed in the authentication process. In such an embodiment, users typically register their devices with the server during the registration and may add one or more new devices later. Alternatively, the authentication server may send a request for a list of wireless devices, such as Wi-Fi networks or nodes, Bluetooth devices, and/or NF devices within within wireless communication range of each of the two devices. When one or more common wireless devices are on the list of IDs from each of the two devices, successful authentication is confirmed.

In another embodiment, the computer enters a mode that scans nearby Bluetooth devices, and if the cell phone registered at the server is identified within the list of surrounding Bluetooth devices, the two devices are concluded to be in the vicinity of each other, and this information provides a confirmation for granting access. In such an embodiment, the server advantageously stores a record of the Bluetooth identification (ID) of the cell phone, which can be registered as part of information relevant to the devices associated with a given user.

Wi-Fi routers typically provide two separate networks, one operating at 2.4 GHz and the other network operating at 5.8 GHz. Some homes or offices may have more than one Wi-Fi router. The computer may be connected to one of these networks, and the cell phone may be connected to another network, or the Wi-Fi connection on the cell phone may be off. In such cases, the server, assuming the cell phone is not necessarily handy, communicates guidance messages to be displayed on the user's computer screen. Examples of such messages are as follows:
1. Please turn on the Wi-Fi on your registered cell phone and connect the cell phone to the same network as your computer.
2. Please connect your computer to the same Wi-Fi network as your cell phone.
3. You may be using a device that has not been registered. Please either use a registered device or register the device you are currently using.

Another option in conjunction with item 1 in the list of messages above is to automate turning on the Wi-Fi connection on the cell phone when the Wi-Fi connection is off at the time of authentication.

Although this disclosure is described in terms of sending one or more MAC addresses or other identifiers of the one or more wireless devices such as Wi-Fi nodes or networks the two devices are connected to, many other information items or identifiers may be accessible to the two units, for example, a computer and a cell phone, operating in the neighborhood or nearby each other. Examples of identifiers of wireless devices include a list, names, and/or identifications of Wi-Fi networks or nodes observed by the two units, Bluetooth devices observed by the two units, NF devices observed by the two units, and location information.

If the identifier sent by the two devices to the server is in plain (unencrypted) text, this critical information is in danger of falling in the hands of hackers or eavesdroppers. One solution is to send a hash of the identifier, for example, hashing the identifier with a salt sent by the server to the two devices, or hashing the identifier by the time of day in a proper or known format. An advantageous option is to hash two of such identifiers together, multiple times, and sending the result. For example, the two devices may see the list of Wi-Fi networks in their neighborhood, and/or the list of Bluetooth devices in their neighborhood. If any of these lists is too long, the items in each list may be ordered, for example, in a lexicographical order or according to measured power level if available. A few are selected, for example, three, 3, from the top of each list and form the hash of all possible pairs, which, for 3 items in each list, results in 9 hash values. Each device sends the resulting hash values as identification signatures to the server, and the server checks to see whether at least some of the signatures are the same. At least one match indicates that the two devices, the cell phone and computer, are in the vicinity of each other. In another embodiment, the MAC address of the Wi-Fi network to which the two devices are connected is hashed with a few selections from a second list, such as list of neighboring Wi-Fi networks or list of neighboring Bluetooth devices, and the two devices send all the resulting signatures to the server. The server checks and verifies the authenticity of the request when at least some of the signatures received from the two devices match each other.

To improve user convenience, instead of asking the user to turn on the Wi-Fi and/or switch the channel the device is connected to, these operations may be automated. This class of embodiments is explained using examples.

In one embodiment, a Wi-Fi unit within the cell phone is automatically turned on when the cell phone is contacted by the authentication server, for example, has received a push notification from the authentication server, for the purpose of verifying a user. The cell phone ranks the SSIDs associated with the cell phone's observable Wi-Fi networks, which are networks that are recorded in the cell phone's internal list of neighboring networks, for example, according to their power level, and/or according to the frequency of cell phone connecting to each of those Wi-Fi network in recent history and connects to such selected networks one after the other. Observable Wi-Fi networks include Wi-Fi nodes or networks that are within wireless communication range of a device, for example, Wi-Fi nodes or networks that a device receives wireless signals from when the device searches for Wi-Fi nodes or networks. For each successful connection, the cell phone computes the hash value of the corresponding signature, which signature may be, for example, the hash of MAC address and/or the SSID of the corresponding Wi-Fi network, with a salt value provided by the authentication server. All the computed hash values are sent from the cell phone to the authentication server where the hash values are compared with the hash value received from the computer. If one of these matches, the procedure is complete, and identity is verified. Multiple variations of this basic embodiment are possible. For example, the cell phone may send the hash values one by one, where the most likely match is sent first, and if the authentication server observes that any cell phone hash value is the same as the hash value sent by the computer, the procedure is complete with identity of the claimant verified, otherwise, the authentication server signals the cell phone to send the next hash value and so on until a match is reached or the procedure is completed without a match and identity claim is refuted, in which case the system may rely on an alternative mechanism, for example, a bio-metric signature, to further evaluate to either verify, or reject, the claimed identity.

As explained above, distant Wi-Fi routers (belonging to neighboring houses or offices) are ones that cannot be accessed (connected to) but are close enough to the two devices (for example, a cell phone and a computer) such that the devices can be recorded in terms of their SSIDs. This process results in access to common information observed by both devices (for example, a cell phone and a computer), and this common information is secret from hackers who are not in the same neighborhood or vicinity of both devices. The SSID of distant Wi-Fi networks may be used as salt in hashing the MAC address of the local Wi-Fi network, the network accessed by the two devices, or may be used as standalone pieces of information that verify the two devices are in the vicinity of each other. For example, each of the two devices may select three of the Wi-Fi networks, hash their respective SSIDs with the time of the day, and separately send this information to the authentication server to be compared with each other. A similar method may be applied to the list names of Bluetooth devices that can be detected by the two devices, such as the cell phone and the computer.

In addition to SSID and MAC address that are inherently static, in other words, remain the same over time, Wi-Fi networks have parameters that change over time, for example, the occupied channel, bandwidth, and other information capable of being obtained by sending a prompt request. This additional information provides another source of shared knowledge between the two devices and may be used in both application categories described above: (1) as the salt for randomizing common information, or (2) as the common information to be hashed using some form of salt, for example, time of the day, random information, user password, and so forth. In any case, the gathered signatures may be used to check the validity of claimant identity.

In many applications, the browser used to access an online service offers the option of storing user passwords. As a result, the user will not need to reenter the password every time he/she wishes to access the same service. Another embodiment of this disclosure includes an extension to the browser, which activates the use of stored passwords only after the person has gone through multi-factor authentication such as disclosed herein.

Authentication methods described herein may be enhanced by checking one or more bio-metric signatures of the user. An example is the use of facial recognition and/or the use of bio-metric sensors available on the cell phone and/or on the computer. When utilizing facial recognition, for example, to stop a hacker from using a picture of the legitimate user, the system may send a request to the user to become actively involved in the process, for example, by requesting that the user blink the user's eyes a specified number of times.

The methods described herein may be enhanced when a connection exists between the computer and the cell phone involved in the authentication procedure. Such a connection may be established using standard or known techniques such as Bluetooth, NF, direct Wi-Fi, or a direct physical connection such as through a universal serial bus (USB) connection. In an embodiment, a STUN (Session Traversal Utilities for Network Address Translation) server may be used to establish a connection between the computer and the cell phone. A direct connection between the computer and the cell phone may be used to establish a shared secret between the two without involving an authentication server. The application of such a shared secret is explained generally below.

Various methods are based on identifying and capturing pieces of information in two devices, where the information captured in the two devices is the same only if the two devices are in the neighborhood (vicinity) of each other. This information may be referred to as environmental signatures. A subset of environmental signatures, which may be measured at each device, is the same in the two devices and are referred to as shared signatures hereafter. For example, a MAC address and SSID of the one or more Wi-Fi networks the two devices are connected to is the same only when the two devices are connected to the same Wi-Fi router or node. Another example is the SSID of neighboring Wi-Fi routers that are observed in a list of neighboring Wi-Fi routers in the two devices, where the two lists include common entries when the two devices are in the vicinity of each other. The shared secret may be mixed, for example, through hashing, with the environmental signatures in each of the two devices, and the mixed forms are sent to the authentication server to be compared with each other. The authentication server checks or verifies when common elements are present in the two sets, which indicates that the set of shared signatures is non-empty. In this example, the authentication is successful, and the identity of the claimant is confirmed by the authentication server. In the absence of a direct connection between the two devices, the authentication server may generate and send a shared secret to the two devices. This shared secret was previously referred to as salt.

The two devices may separately send their respective measurements of environmental signatures, with or without hashing, to the authentication server to be compared at the authentication server to find one or more common elements in the two sets. In another embodiment, the two devices enter a mutual checking and verification phase to verify that their measured environmental signatures include shared entries and send the confirmation to the authentication server to grant access. To conduct this operation, each device checks the entries in the list of environmental signatures claimed by the other device. Mutual verification is advantageous because one of the two devices may have been compromised. To perform such a mutual verification, each device computes a hash of each element in its environmental signature set. The hash is typically 256 bits, although other quantities of bits may be utilized. Each device may send a portion of each of the hash values to the other device. For example, a first device, such as the computer, sends the first 32 bits of each of the computer's hash values, where each hash value corresponds to hashing one of the environmental signatures several times, say 1000 times, with itself, to the second device, such as the cell phone, while the second device sends the last 32 bits of each of the second device's hash values to the first device. In this manner, each device identifies one or more shared signatures and verifies the validity of the environmental signatures of the other device. Because a small subset of bits is sent to the other device for verification, a small amount of information from the entire environmental signature sets is transmitted by each of the two devices. This process reduces the possibility of a potential eavesdropper reconstructing complete environmental signatures, which potential eavesdropper could use the result of the measurement to impersonate the role of a device that may be operating in the vicinity of a legitimate unit or device.

In an embodiment, the two devices scan their environment for list of IDs such as SSIDs of neighboring wireless devices, such as Wi-Fi routers, Bluetooth devices, NF devices, on-line printers, and so forth. Each device forms a list of top K, such as K=4, recorded IDs such as SSIDs, and separately sends the list to the server, together with the unique ID of each of the two devices. The server compares the two lists and grants access when the unique IDs of the devices are part of a database as devices registered by the user and at least a subset of IDs in the two lists match with each other, for example, when 2 out of 4 of the IDs are the same. In another embodiment, the devices are registered under a unique ID that is used by the server to send the devices the push notification to initiate the authentication process. Because these IDs are unique, the two devices may simply send the list of SSIDs, without transmitting the device ID. In other words, in such a simplified implementation, only the legitimate devices are presumed to respond to the push notification sent by the server. In another embodiment, the time between receiving a response from the two devices is recorded at the server and a time-out is triggered when the delay exceeds some set threshold, for example, one minute. Other variations of this basic setup are possible. For example, the server may send a salt as part of a push notification, and the two devices send the items in their respective list of neighboring IDs after each item (such as an SSID) is hashed with the salt value. In another configuration, the time of the day is used as the salt in hashing and sending the items in the list of IDs. In another embodiment, the address of the server, which is known to the two devices, is used as salt to be hashed with the items in the list of IDs gathered by the two devices.

The disclosed multi-factor authentication may be used in conjunction with on-line services or when granting access to restricted networks. One such on-line service is described herein.

Another aspect of this disclosure concerns an on-line service based on encrypting data with an expiration date and/or time, which could be used together with the multi-factor authentication described herein. The method of encrypting data with an expiration date and/or time may be also used as an on-line service with another form of authentication, different from or including the multi-factor authentication methods described herein. The on-line service involves sharing sensitive documents that are required to be encrypted at the sender's side and decrypted at the receiver's side. The on-line service includes a computer program running on a client device, such as a personal computer or a tablet, and facilitates selecting a document on the client device, encrypting the document, and sending the encrypted file through email as an attachment, or sharing the encrypted file using a cloud file sharing service such as OneDrive. The method utilizes a server in the cloud that facilitates the sharing of an encrypted file without the need to decrypt the file before the file reaches its destination.

In one embodiment, the sender and the receiver are both registered with the server, and may be authenticated, for example, using the disclosed multi-factor authentication procedure. In another embodiment, only the sender is registered, and the receiver proves the receiver's identity by providing evidence of possessing the encrypted data. One role of the server is to provide the sender with a public key and provide the receiver with the corresponding private key. In addition, an index pointing to a location where the corresponding private key is stored at the server, referred to as a location index, is sent to the sender. The sender, upon authenticating with the server, receives a public key and its associated key location index from the server. The server generates a new public and private key pair upon receiving a new request from a first user, referred to as a sender, who wants to send an encrypted document to a second user, referred to as a receiver. The newly generated public key and its associated key location index are transmitted to the sender over a secure channel, and the corresponding private key is stored in a row in a database at the server, such as at a location specified by its associated key location index. Database rows are indexed sequentially or are specified by the key location index that may be formed in different manners, and the empty rows are recorded. A second database keeps track of the current size of the first or main database and the indices of empty rows. The newly generated private key, plus its associated key location index, is stored in an empty row, and the corresponding public key and key location index are sent to the sender. The sender uses the public key to encrypt the document and appends the key location index pointing to the row storing the corresponding private key at the server to the encrypted document. In such an implementation, the key location index may be simply a random string, for example 64 bits, generated by the server. The receiver, upon receiving the encrypted file, extracts the key location index, authenticates with the server, for example, when prior registration of receiver exists, and transmits the extracted key location index to the server. The authentication of the receiver may be summarized to just sending the key location index. The server, using a secure channel, sends the private key to the receiver, erases the corresponding row, and stores the current status of the main database in the auxiliary database. The receiver uses the private key to decrypt the file.

In another embodiment, the server generates public and private key pairs, and stores each key pair in two consecutive rows of the main database, specified by a key location index, such as a random string of, for example, 64 bits. Each row includes a single bit indicator that, when set to one, identifies the corresponding public key as already used. In this arrangement, once the receiver sends the request for receiving a particular private key, the server takes the following actions: (1) transmits the private key to the receiver over a secure channel, (2) generates a new key pair and replaces the key pair that was used with the new key pair, and (3) changes the bit indicator corresponding to the newly generated key pair to zero, indicating that the corresponding key pair is fresh and can be used when a new request comes in. In this implementation, the key location index, which is a random string, is advantageously generated anew, although the existing key location index may be reused. In this implementation, when the server uses all the fresh key pairs, the main database is enlarged to make room for more newly generated key pairs. Each key pair, upon being used, such as when a private key is extracted from the main database and sent to a receiver, is replaced with a new pair to be ready to serve the subsequent incoming request. In one embodiment, to verify the validity and legitimacy of incoming requests, a document signature is assigned to each encrypted document. The document signature is composed, for example, of the first 64 bits of the encrypted document hashed with the key location index. This signature is sent by the sender to the server to be stored in conjunction with the corresponding private key to enable the server to verify that the receiver is truly in possession of the encrypted document. The key location index is advantageously sent by the server to the sender and is attached to the encrypted document. In this manner, the receiver, upon receiving the encrypted document, regenerates the document signature and sends the key location index plus the document signature to the server. The reason for sending the key location index to the server is to facilitate the search in the server database. In practice, storing only the document signature at the server is sufficient, in which case, the receiver sends only the document signature to the server. The sender in turn receives the corresponding private key from the server.

In another embodiment, the sender is given an option to set a timer for the lifetime of the encryption key, in which case, the value of the timer is set by the sender and sent to the server. The server keeps track of the time since the process of sending the public key has started, and if the lifetime of a key pair expires prior to receiving a request for the corresponding private key, the key pair is removed from the database. In such a case, the data relevant to the erased key pair is stored in an auxiliary database such that when a request for accessing private key arrives after the key has expired, the server informs the sender and the receiver, for example, in the case when the sender decides to share the file anew.

In another embodiment, the sender sends a digital signature unique to the encrypted file to the server. As an example, two segments from the encrypted file, for example the first 256 bits and the last 256 bits, are hashed together. The result of the hashing operation is shortened, to, for example, 64 bits, by extracting a subset of bits. These bits, referred to as a “digital signature associated with the encrypted file,” are sent to the server where the bits are stored as part of information kept at the server side related to a particular file. The digital signature associated with the encrypted file is used to verify whether an individual requesting to have a copy of the private key for decrypting the encrypted file is truly in possession of the encrypted file. In addition to the digital signature associated with the encrypted file, the sender forms a second digital signature, referred to as a “digital signature associated with the unencrypted file,” which is unique to the original file in plain text. The digital signature associated with the unencrypted file is transmitted to the server where the digital signature is stored as part of information kept at the server side related to a particular file. The method for generating the digital signature associated with the unencrypted file is similar to that of generating the digital signature associated with the encrypted file, but the method operates on segments extracted from the original file in plain text. Upon decrypting a file, the individual at the receiver side computes the digital signature associated with the unencrypted file and sends the digital signature associated with the unencrypted file to the server as a confirmation for successful decryption. Upon receiving such a confirmation, the server can delete the entry relevant to the file, assuming other criteria for the deletion are satisfied as well. In an embodiment, the criteria for deleting an entry at the server side include a counter determining the number of times the private key can be downloaded prior to the deletion of its relevant entry from the server database. This feature is useful when the sender has emailed the encrypted file to more than one recipient. The menus associated with such an embodiment allows the sender to select the lifetime of a key as well as the number of times the private key can be retrieved for decrypting its associated file. The condition for deletion of the entry from the server-side database is the OR of these two conditions, for example, when the key is retrieved for the maximum number of times allowed by the original sender or when the lifetime of the key set by the sender is reached (key has expired).

In another embodiment, a file is encrypted at the sender's side using software installed on the sender's computer, wherein the software asks the sender to specify the lifetime of the encryption key, and/or the number of times the private key can be retrieved from the server database. The software, upon encrypting the file, appends the expiration time of the encryption key to the file name, as well as a pre-selected fixed suffix that informs the receiver side that a particular software, such as the software based on the method disclosed herein, should be used for opening (decrypting) the file. For example, a file XYZ.u is named XYZ.u_10 pm_September_second_TE, where _TE stands for transparent encryption, a general term for disclosed encryption techniques.

In another embodiment, users of the disclosed encryption techniques go through a registration phase wherein a login name, for example, an email address, plus a password is registered and corresponding to each user at the authentication server. The registration phase may also include registering devices belonging to each user, for example, using a unique ID specific to each device. In one embodiment, the sender specifies the login names of individuals who can receive a copy of the encryption key from the server. The login names of legitimate recipients are recorded at the server, and hereafter, only the individuals included in the list of legitimate recipients can receive a copy of the private key. To receive a copy of the private key for decryption, legitimate recipients first undergo an authentication phase, for example, using methods, such as disclosed herein, in the context of multi-factor authentication and demonstrate possession of the encrypted file.

The following descriptions of figures illustrate various embodiments of above methods and apparatus.

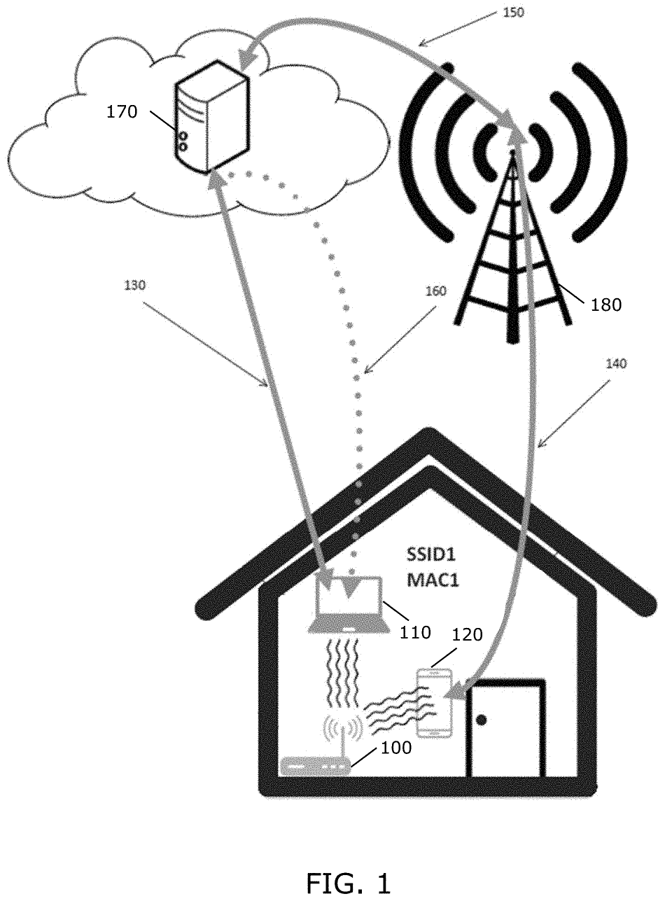

FIG. 1 depicts a basic setup wherein a router 100 is connected to two devices, a computer 110 and a cell phone 120. The computer 110 is connected through a bi-directional connection 130 to an authentication server 170. The cell phone 120 is connected through a bi-directional connection 140 to a nearby wireless base-station 180 and connected to the authentication server 170 through another bi-directional connection 150. The authentication server 170 compares the environmental signatures received through the bi-directional connections 130 and 150, and when a match is detected, grants the computer 110 access by sending an access token to the computer 110 through communication link 160. The environmental signature may be formed, for example, from the MAC address of the router, hashed with its SSID, and hashed with a salt received at the computer 110 and at the cell phone 120 through bi-directional links 130 and 140, respectively. The connections and links described herein may be wireless or wireline communications resources as known in the industry.

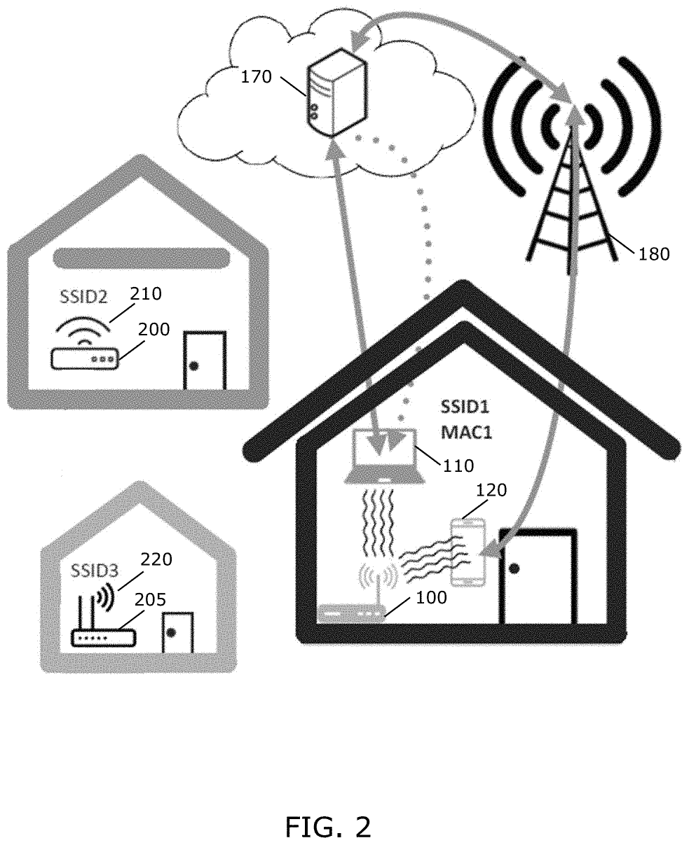

FIG. 2 is a diagram illustrating environmental signatures including SSID2 of a first neighboring router 200 and SSID3 of a second neighboring router 205, in addition to MAC1 and SSID1 of the local router 100. Radio frequency radiation emissions 210 and 220 emitted by router 200 and router 300, respectively, are sensed at the computer 110 and at the cell phone 120 involved in authentication. MAC2 of the first neighboring router 200 and MAC3 of the second neighboring router 205 are not part of the environmental signatures because the cell phone 120 and computer 110 observe the names or SSIDs of one or more neighboring routers, but not their MAC addresses. MAC address may be recorded only after connection to the router is established.

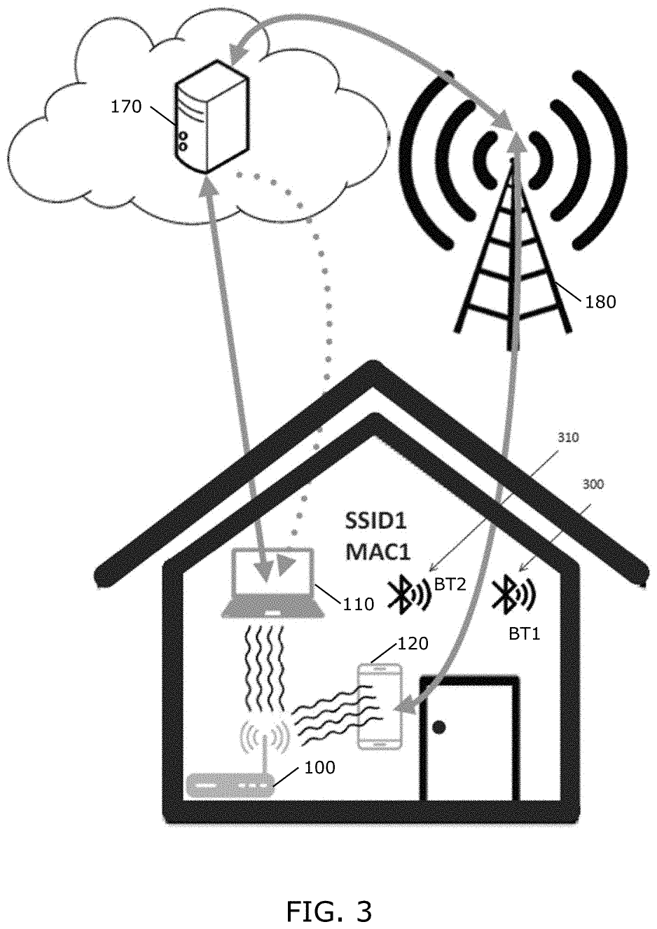

FIG. 3 is a diagram illustrating environmental signatures including the names BT1 and BT2 of Bluetooth devices 300 and 310 in a neighborhood of (nearby) the two devices, the computer 110 and the cell phone 120, involved in authentication.

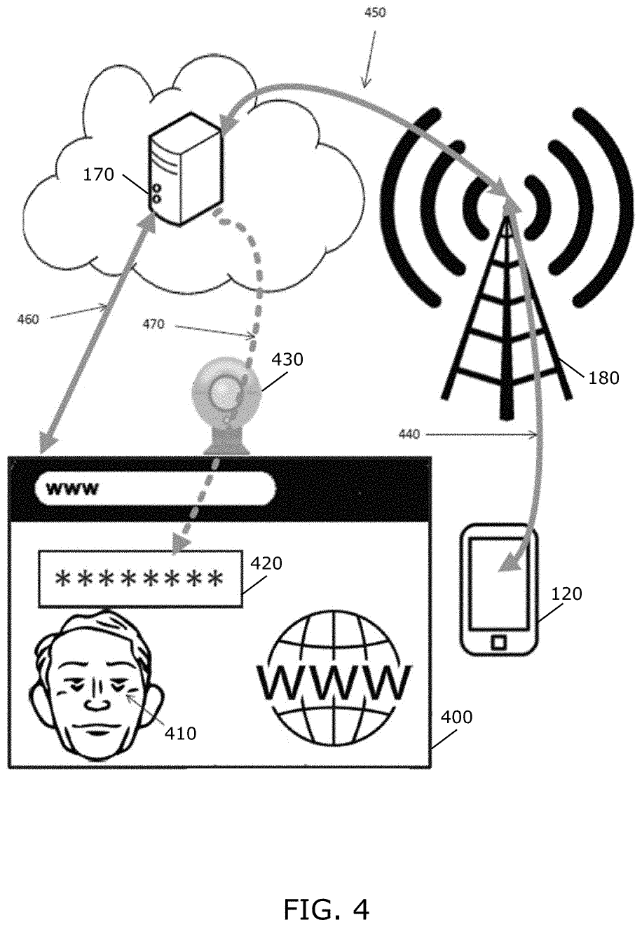

FIG. 4 depicts a computer 400 used by a user 410 to access an on-line security service. The browser on the computer 400 has stored a password 420 associated with the on-line security service. Advantageously, the computer 400 provides the stored password 420 to the external web-site for access only when two-factor authentication is verified. This process utilizes a cell phone 120 and a computer 400 as the two devices, bi-directional links 440, 450 connecting the cell phone 120 to the authentication server 170, a bi-directional link 460 connecting the computer 400 to the authentication server 170, and a link 470 for sending the authorization response to the computer 400, which response results in applying the stored password when the authentication is affirmative. Authentication may advantageously be enhanced using a webcam 430 to capture an image of the face of the user for facial recognition, wherein the user is asked to actively participate in the authentication procedure, for example, by blinking the user's eyes at a certain time or blinking the user's eyes a specific number of times upon a cue, such that hackers cannot use pre-stored images of the person to impersonate the person's presence in the facial recognition process.

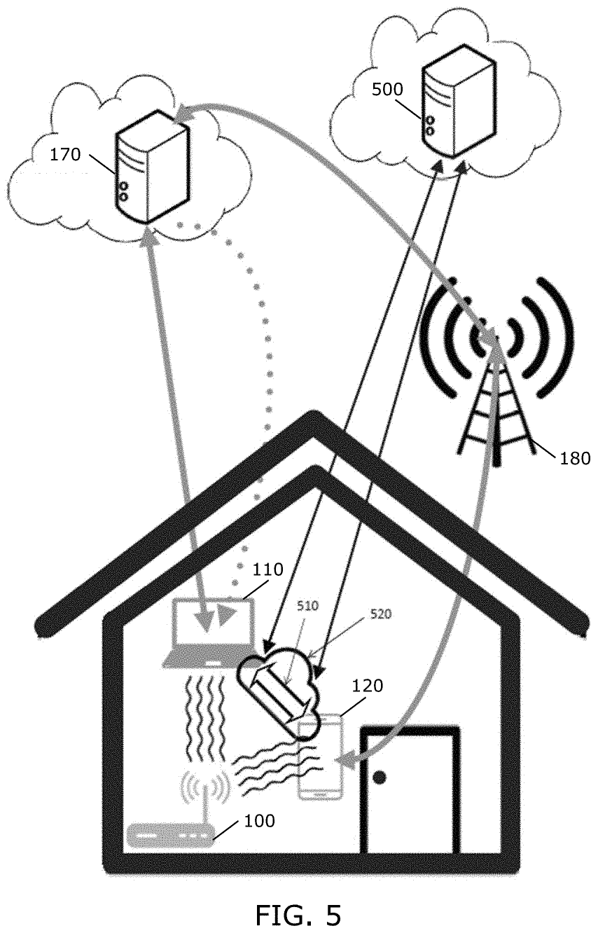

FIG. 5 depicts an embodiment where a STUN server 500 is used to provide a direct link 510, through the cloud 520, between the two devices 110, 120 involved in the authentication. Such a direct link 510 can be used by the two devices 110, 120 to mutually identify elements that are the same in the two environmental signature sets and thereby establish when any elements are in the set of shared signatures between the devices 110, 120.

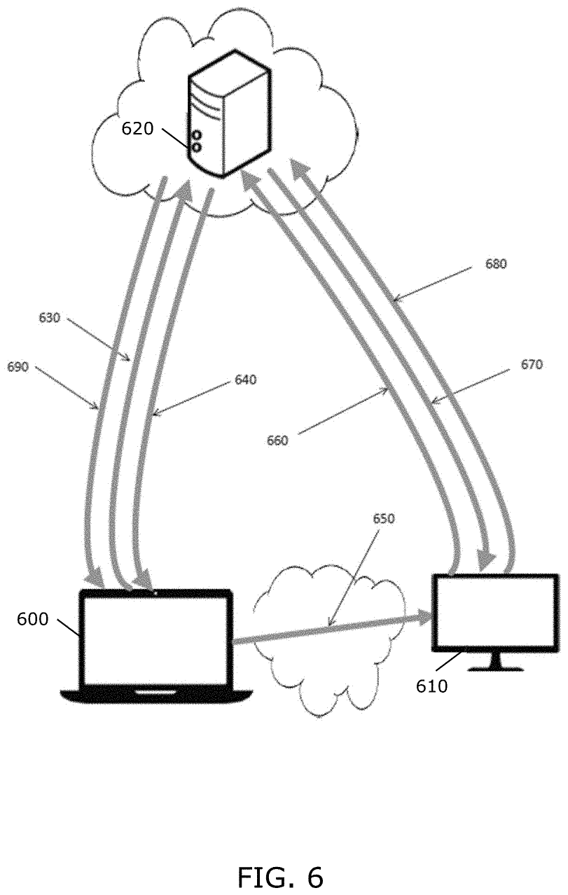

FIG. 6 illustrates a method of transparent encryption involving a sender device 600, a receiver device 610, and a server 620. A first request 630 sent to the server 620 by the sender device 600 requests a public key. The request 630 includes other relevant factors, such as the lifetime of the key, and/or a list of legitimate recipients. The server 620 sends a response 640 including the requested public key. A file is shared 650, for example, by sending the file as an email attachment or uploading the file to a cloud storage provider to share the file with selected recipients. The receiver device 610 contacts the server 620 and requests 660 a copy of the private key associated with the file. The request 660 includes transmission of a relevant digital signature associated with the encrypted file such that the server 620 can check whether the receiver 610 is actually in possession of the encrypted file. The server 620 sends a response 670 including the private key. The phase in between the initial request 660 and the final response 670 may require that the receiver 610, as an individual and/or as a device, authenticates with the server 620. The receiver device 610 sends 680 the digital signature associated with the decrypted file to the server 620 such that the server 620 decrements the counter counting the number of times the file is accessed and deletes the key once the number of times the file is accessed has reached a set limit. The server 620 sends 690 an email to the sender 600 indicating the file has been accessed, and optionally includes the login name of the receiver 610 who has accessed the file, and optionally includes a message indicating the number of times the file is accessed and/or whether the lifetime of the file has expired.

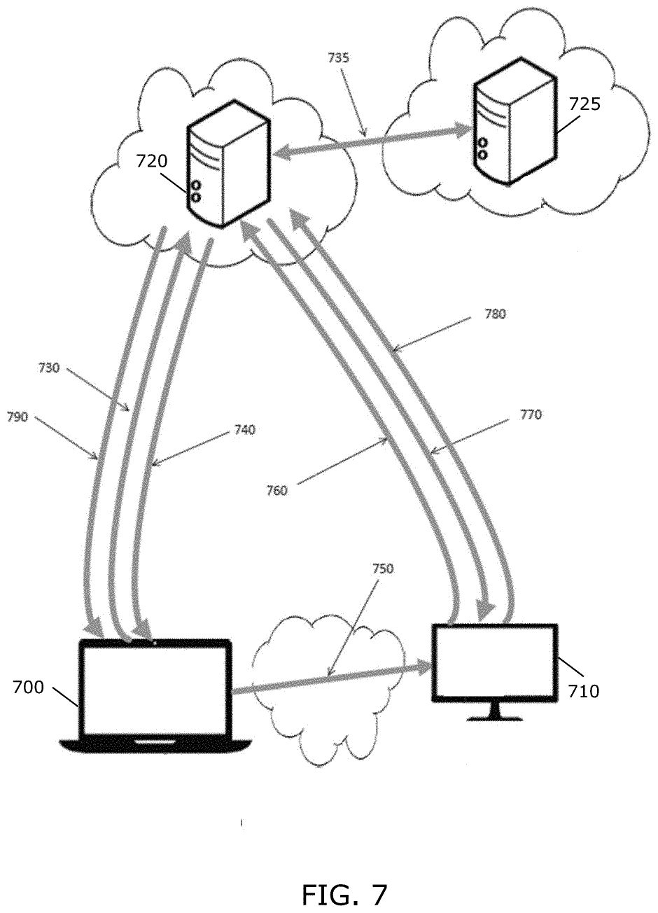

FIG. 7 illustrates an embodiment using a second server to store part of the private encryption keys. For example, the private keys may be chopped into two equal size pieces, and each piece is stored on one of two servers 720, 725. This embodiment of transparent encryption involves a sender device 700, a receiver device 710, a first server 720, and a second server 725. A first request 730 sent to the first server 720 by the sender device 700 requests a public key. The request 730 includes other relevant factors, such as the lifetime of the key, and/or a list of legitimate recipients. Upon receiving and verifying the legitimacy of a request for a copy of a private key, the first server 720 contacts the second server 725 using a secure communication link 735. The second server 725 sends the pieces of the corresponding key stored at the second server 725 to the first server 720 to form the complete private key at the first server 720. The first server 720 sends a response 740 including the requested public key to the. A file is shared 750, for example, by sending the file as an email attachment or uploading the file to a cloud storage provider to share the file with selected recipients. The receiver device 710 contacts the first server 720 and requests 760 a copy of the private key associated with the file. The request 760 includes transmission of a relevant digital signature associated with the encrypted file such that the first server 720 can check whether the receiver 710 is actually in possession of the encrypted file. Upon receiving and verifying the legitimacy of a request for a copy of a private key, the first server 720 contacts the second server 725 using a secure communication link 735. The second server 725 sends the pieces of the corresponding key stored at the second server 725 to the first server 720 to form the complete private key at the first server 720. The first server 720 sends a response 770 including the complete private key to the sender device 700. Using two servers guarantees if one of the two servers is hacked, the complete private keys remain unknown to the hacker. In an alternative embodiment, instead of chopping the private key into two pieces, the private key is masked, for example, using bit-by-bit addition modulo two, by a randomly generated key or mask of the same size. The result of the masking is two vectors, a masked key that is stored at one of the two servers 720, 725 and a mask that is stored at the other server 725, 720. Upon retrieving the vector stored at the second server 725 and adding the corresponding vector stored at the first server, for example, using bit-by-bit addition modulo two, the original private key may be reconstructed.

A method performed by a server includes receiving, from a first device, a request for authentication by the server, wherein the request includes a unique identifier of the first device, and upon verifying that the unique identifier is registered at the server, sending a push notification to the first device and to a second device registered as associated with the first device. A first list of identifiers (IDs) of at least one wireless device within wireless communication range of the first device is received from the first device, and a second list of IDs of at least one wireless device within wireless communication range of the second device is received from the second device. The first list of IDs and the second list of IDs are compared to identify common IDs between the first list and the second list. Successful authentication of the first device is confirmed when at least one common ID is identified. The IDs may include at least one of a Service Set Identifier (SSID) of a Wi-Fi node, an identification of a Bluetooth device, and an identification of a near field device. The push notification may include a first salt value selected by the server. Each ID of the first list of IDs may be received separately by the server from the other IDs of the first list of IDs, and each ID of the second list of IDs may be received separately by the server from the other IDs of the second list of IDs, for example in different messages. The method may further include sending, to the first device, a message requesting a user perform a task involving a biometric check; receiving results of the biometric check; and checking that the results of the biometric check are consistent with expected results of the biometric check before confirming successful authentication of the first device. The method may further include sending a public key to the first device upon confirming successful authentication of the first device. The method may further include sending an access token to a provider of a service indicated in the request upon confirming successful authentication of the first device.

A method performed by a first device includes sending, by the first device, a request for authentication to a server, wherein the request includes a unique identifier of the first device, wherein the unique identifier is registered at the server and receiving, by the first device, a push notification from the server upon verifying the unique identifier of the first device. In response to receiving the push notification, a list of IDs of at least one wireless device within wireless communication range of the first device is sent to the server and confirmation of authentication is received from the server. The IDs may include at least one of a Service Set Identifier (SSID) of a Wi-Fi node, an identification of a Bluetooth device, and an identification of a near field device. The push notification may include a first salt value, and the method may further include hashing the list of IDs with the first salt value before sending the list to the server. The method may further include hashing the unique identifier with a second salt value selected by the first device before sending the unique identifier to the server and sending the second salt value to the server. A signature may be extracted from the unique identifier, and the signature may be sent to the server. Each ID of the list of IDs may be sent separately to the server from the other IDs of the list of IDs, for example, in a different message. The method may further include receiving, from the server, a message requesting a user of the first device perform a biometric check, displaying the message, and sending, to the server, results of the biometric check.

A method performed by a second device includes receiving, by the second device associated with a first device, a push notification from a server, wherein the first device and the second device are registered with the server and identifying at least one wireless device within wireless communication range of the second device. In response to receiving the push notification, a list of IDs of the at least one wireless device within wireless communication range of the second device is sent to the server. The IDs may include at least one of a Service Set Identifier (SSID) of a Wi-Fi node, an identification of a Bluetooth device, and an identification of a near field device. The push notification may include a first salt value, and the method may further include hashing the list of IDs with the first salt value before sending the list to the server. Each ID of the list of IDs may be sent separately to the server from the other IDs of the list of IDs, for example, in a different message.

A method performed by a system includes sending, by a first device, a request for authentication to a server, wherein the request includes a unique identifier of the first device, wherein the unique identifier is registered at the server, and receiving, from the first device, the request for authentication by the server. Upon verifying that the unique identifier is registered at the server, a push notification is sent to the first device and to a second device registered at the server as associated with the first device. In response to receiving the push notification, a first list of IDs of at least one wireless device within wireless communication range of the first device is sent from the first device to the server. In response to receiving the push notification, a second list of IDs of at least one wireless device within wireless communication range of the second device is sent from the second device to the server. The first list of IDs is received from the first device, and the second list of IDs is received from the second device. The first list of IDs and the second list of IDs are compared to identify common IDs between the first list and the second list. Successful authentication of the first device is confirmed when at least one common ID is identified. The method may further include sending, to the first device, a message requesting a user perform a task involving a biometric check; receiving, by the first device, the message requesting a user of the first device perform a biometric check, displaying the message, and sending, to the server, results of the biometric check; receiving results of the biometric check from the first device; and checking that the results of the biometric check are consistent with expected results of the biometric check before confirming successful authentication of the first device. The first device and the second device may be connected to a first router having a first ID, and the first list of IDs includes the first ID and the second list of IDs includes the first ID.

A non-transitory computer-readable storage medium has stored instructions that are operative, when executed by a processor, to cause the processor to perform any of the methods described herein.

The present disclosure may be embodied in other forms without departing from its spirit or essential characteristics. The described embodiments are to be considered as examples, and in all respects are merely illustrative and not restrictive.

What is claimed is:

1. A method performed by a server, the method comprising:
receiving, from a first device, a request for authentication by the server, wherein the request includes a unique identifier of the first device;
upon verifying that the unique identifier is registered at the server, sending a push notification to the first device and to a second device registered at the server as associated with the first device;
receiving, from the first device, a first list of identifiers (IDs) of at least one wireless device within wireless communication range of the first device;
receiving, from the second device, a second list of IDs of at least one wireless device within wireless communication range of the second device;
comparing the first list of IDs and the second list of IDs to identify common IDs between the first list and the second list; and
confirming successful authentication of the first device when at least one common ID is identified.

2. The method of claim 1, wherein the IDs include at least one of a Service Set Identifier (SSID) of a Wi-Fi node, an identification of a Bluetooth device, and an identification of a near field device.

3. The method of claim 1, wherein the push notification includes a first salt value selected by the server.

4. The method of claim 1, wherein each ID of the first list of IDs is received separately by the server from the other IDs of the first list of IDs, and wherein each ID of the second list of IDs is received separately by the server from the other IDs of the second list of IDs.

5. The method of claim 1, further comprising:
sending, to the first device, a message requesting a user perform a task involving a biometric check;
receiving results of the biometric check;
checking that the results of the biometric check are consistent with expected results of the biometric check before confirming successful authentication of the first device.

6. The method of claim 1, further comprising sending a public key to the first device upon confirming successful authentication of the first device.

7. The method of claim 1, further comprising sending an access token to a provider of a service indicated in the request upon confirming successful authentication of the first device.

8. A method comprising:
sending, by a first device, a request for authentication to a server, wherein the request includes a unique identifier of the first device, wherein the unique identifier is registered at the server;
receiving, by the first device, a push notification from the server upon verifying the unique identifier of the first device;
in response to receiving the push notification, sending, to the server, a list of IDs of at least one wireless device within wireless communication range of the first device; and
receiving confirmation of authentication from the server.

9. The method of claim 8, wherein the IDs include at least one of a Service Set Identifier (SSID) of a Wi-Fi node, an identification of a Bluetooth device, and an identification of a near field device.

10. The method of claim 8, wherein the push notification includes a first salt value, the method further comprising hashing the list of IDs with the first salt value before sending the list to the server.

11. The method of claim 10, further comprising hashing the unique identifier with a second salt value selected by the first device before sending the unique identifier to the server and sending the second salt value to the server.

12. The method of claim 1, wherein a signature is extracted from the unique identifier and the signature is sent to the server.

13. The method of claim 8, further comprising receiving, from the server, a message requesting a user of the first device perform a biometric check, displaying the message, and sending, to the server, results of the biometric check.

14. A method comprising:
receiving, by a second device associated with a first device, a push notification from a server, wherein the first device and the second device are registered with the server;
identifying at least one wireless device within wireless communication range of the second device; and
in response to receiving the push notification, sending, to the server, a list of IDs of the at least one wireless device within wireless communication range of the second device.

15. The method of claim 14, wherein the IDs include at least one of a Service Set Identifier (SSID) of a Wi-Fi node, an identification of a Bluetooth device, and an identification of a near field device.

16. The method of claim 14, wherein the push notification includes a first salt value, the method further comprising hashing the list of IDs with the first salt value before sending the list to the server.

17. The method of claim 14, wherein each ID of the list of IDs is sent separately to the server from the other IDs of the list of IDs.

18. A method performed by a system, the method comprising:
sending, by a first device, a request for authentication to a server, wherein the request includes a unique identifier of the first device, wherein the unique identifier is registered at the server;
receiving, from the first device, the request for authentication by the server;
upon verifying that the unique identifier is registered at the server, sending a push notification to the first device and to a second device registered at the server as associated with the first device;
in response to receiving the push notification, sending from the first device to the server, a first list of IDs of at least one wireless device within wireless communication range of the first device;
in response to receiving the push notification, sending from the second device to the server, a second list of IDs of at least one wireless device within wireless communication range of the second device;
receiving, from the first device, the first list of IDs;
receiving, from the second device, the second list of IDs;
comparing the first list of IDs and the second list of IDs to identify common IDs between the first list and the second list; and
confirming successful authentication of the first device when at least one common ID is identified.

19. The method of claim 18, further comprising:
sending, to the first device, a message requesting a user perform a task involving a biometric check;
receiving, by the first device, the message requesting a user of the first device perform a biometric check, displaying the message, and sending, to the server, results of the biometric check;
receiving results of the biometric check from the first device; and
checking that the results of the biometric check are consistent with expected results of the biometric check before confirming successful authentication of the first device.

20. The method of claim 18, wherein the first device and the second device are connected to a first router having a first ID, wherein the first list of IDs includes the first ID and the second list of IDs includes the first ID.
